(19) United States
(12) Patent Application Publication
(10) Pub. No.: US 2011/0179022 A1
(43) Pub. Date: Jul. 21, 2011

(54) METHOD OF ANALYZING CLAIMS OF A PATENT DOCUMENT AND PATENT ANALYSIS SYSTEM THEREOF

(76) Inventor: Chia-Hung Chen, Taipei Hsien (TW)

(21) Appl. No.: 12/938,386

(22) Filed: Nov. 3, 2010

(30) Foreign Application Priority Data
Jan. 18, 2010 (TW) 099101190

(51) Int. Cl. G06F 17/30

(52) U.S. Cl. 707/723; 707/769; 707/E17.014

(57) ABSTRACT

A method of analyzing claims of a patent includes retrieving a patent document. The patent document includes at least one claim. The method further includes analyzing the claim and a vocabulary database so as to generate at least one conjunction term of the claim with an analysis device, and evaluating quality of the claim according to the at least one conjunction term with the analysis device.

### BACKGROUND OF THE INVENTION

1. Field of the Invention

The present invention relates to a method of analyzing claims of a patent document and a patent analysis system thereof, and more particularly, to a method of automatically evaluating quality of a patent document by analyzing conjunction terms and elements in claims and a patent analysis system thereof.

2. Description of the Prior Art

A conventional patent analysis method analyzes a patent document by manpower, and quality of the patent document can not be evaluated automatically with a concrete index in the conventional analysis procedure. Patent evaluation executed by man-made experiences has low processing efficiency, and the conventional patent analysis method spends human resources and working hours. In addition, the conventional patent analysis method is difficult to manage the approved patent and wastes unnecessary expense. Therefore, the patent may have no substantial profit till the expiration.

Some kinds of judgmental standards and rules are created for simplifying inspection and evaluation of the patent analysis. For example, cited numbers can be an index for evaluating importance of the patent document. However, the cited number of the patent document only represents its frequency of the prior art, which means the cited number is a quantification index unrelated to the quality of the patent document. The importance of the patent document should refer to the claim scope so as to evaluate the quality of the patent document. For example, a method of analyzing elements of the claims for evaluating the importance of the patent document is disclosed in CN patent application no.200410059431.1. However, it does not consider other factors besides the composing elements in evaluation of the patent document. For example, connection between the composing components is another important factor for evaluating the quality of the patent document. Thus, design of a patent analysis system capable of automatically analyzing the patent document effectively is an important issue in the patent management.

### SUMMARY OF THE INVENTION

The present invention provides a method of automatically evaluating quality of a patent document by analyzing conjunction terms and elements in claims and a patent analysis system thereof for solving above drawbacks.

According to the claimed invention, a method of analyzing claims of a patent document includes retrieving a patent document having at least one claim, analyzing the claim and a vocabulary database so as to generate at least one conjunction term of the claim with an analysis device, and evaluating quality of the claim according to the at least one conjunction term with the analysis device.

According to the claimed invention, a patent analysis system includes a storage module for storing a patent document and a vocabulary database. The patent document includes at least one claim. The patent analysis system further includes an analysis device for analyzing the claim and the vocabulary database so as to generate at least one conjunction term of the claim and to evaluate quality of the claim according to the at least one conjunction term.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a patent analysis system capable of automatically analyzing claims of a patent document according to a preferred embodiment of the present invention.

FIG. 2 is a flow chart of automatically analyzing the claims of the patent document with the patent analysis system according to the preferred embodiment of the present invention.

### DETAILED DESCRIPTION

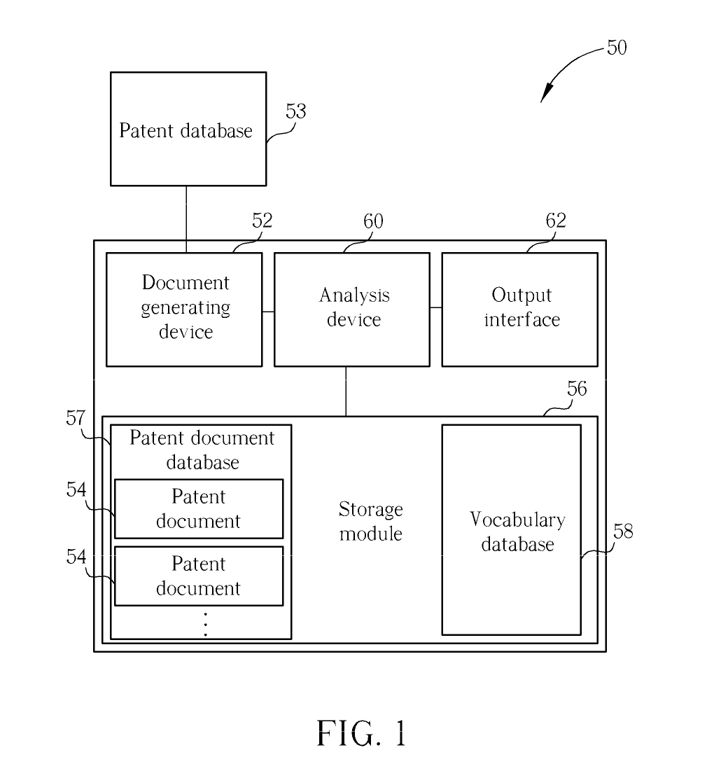

Please refer to FIG. 1. FIG. 1 is a functional block diagram of a patent analysis system 50 capable of automatically analyzing claims of a patent document according to a preferred embodiment of the present invention. The patent analysis system 50 includes a document generating device 52 for retrieving a patent document 54. The patent document 54 includes at least one claim. The document generating device 52 can be hardware, firmware, or software, such as an application program executed by a processing unit. For example, the document generating device 52 can retrieve the patent document 54 from a patent database 53 according to information of the patent document 54, such as an application number, a publication number, a patent number, an applicant's information, and so on. The patent database 53 can be a remote server or a local database, such as the official patent database for storing native patent documents or the commercial patent database set in an intranet system. In addition, the patent document 54 can be stored and analyzed in the patent database 53 instead of being downloaded, such as logging in the patent database 53 to execute patent analysis in a cloud computing architecture.

The patent analysis system 50 further includes a storage module 56 for storing a patent document database 57 and a vocabulary database 58. The patent document database 57 is for storing the patent document 54. It should be mentioned that the patent document 54 also can be collected and stored in the patent document database 57 so that the user does not need to retrieve the corresponding patent document from the patent database 53 with the document generating device 52, which means the document generating device 52 can be utilized selectively. The vocabulary database 58 is for storing vocabularies related to the patent document 54. For example, the vocabulary database 58 stores series of conjunction terms, such as couple, connect, electrically connect, pivot, engage, dispose, fix, wedge, and so on, so as to define structural relation or functional relation between elements in the claim. The element can be a structural element, a step, a chemical element, and so on. The vocabulary database 58 can further store several kinds of terms, such as a necessary term, a term logically paired with other term, a term correlated with other terms, and so on. The necessary term represents an indispensable term from the element in a specific technology domain corresponding to the claim, which means the necessary term belongs to general prior art and is irrelevant to quality of the claim. For example, as for the patent of semiconductor process, a word “substrate” belongs to the general prior art and is irrelevant to the quality of the claim as the necessary term. The term logically paired with other term represents a pair of terms appearing from the element in the specific technology domain corresponding to the claim, which means the pair of terms can be considered as a single element. For example, as for the patent of the semiconductor process, “forming a mask” and “removing the mask” can be considered as a pair of element in the claim, so that the pair of terms is considered as the single element. In addition, the term correlated with other terms represents the elements having the same meaning in the specific technology domain corresponding to the claim, which means a plurality of words having the same meaning can be considered as the single element. For example, as for the patent of the semiconductor process, “disposing an electroplate layer” and “forming an electroplate layer” stand for the same meaning, so that the two terms can be considered as the single element. The above-mentioned terms, such as the conjunction term, the necessary term, the term logically paired with other term, the term correlated with other terms, and so on, can be set according to the specific technology domain, such as the semiconductor process, mechanical structure, circuit layout, software, biology, chemical technology, and so on. The terms can further be set according to different patent categories, such as a structure-type patent, a method-type patent, a system-type patent, and so on. Furthermore, the terms generated from the claim are not limited to the necessary term, the term logically paired with other term, the term correlated with other terms, and so on. The terms can be selected from a group consisting of the conjunction term, the necessary term, the term logically paired with other term, the term correlated with other terms, the other additional term, and a combination thereof.

The patent analysis system 50 further includes an analysis device 60 for storing the patent document 54 generated from the document generating device 52 to the storage module 56. And the analysis device 60 is for analyzing the claims of the patent document 54 and the vocabulary database 58 so as to generate the conjunction term, the necessary term, the term logically paired with other term, the term correlated with other terms, and for calculating the number of conjunction terms and elements and then further for evaluating the quality of the claim according to the above-mentioned terms. The analysis device 60 can be hardware, firmware, and software, such as the application program executed by the processing unit. In addition, the analysis device 60 can analyze the terms via semantic analysis mechanism and fuzzy logic formula. Analysis result of the analysis device 60 can be stored in the storage module 56. The patent analysis system 50 further includes an output interface 62 for outputting the result of the analysis device 60 stored in the storage module 56, such as a rating or a grade corresponding to the patent document 54 generated from the analysis device 60. The output interface 62 can be a display interface for displaying the above-mentioned result. The output interface 62 can further be a printing interface for printing the above-mentioned result.

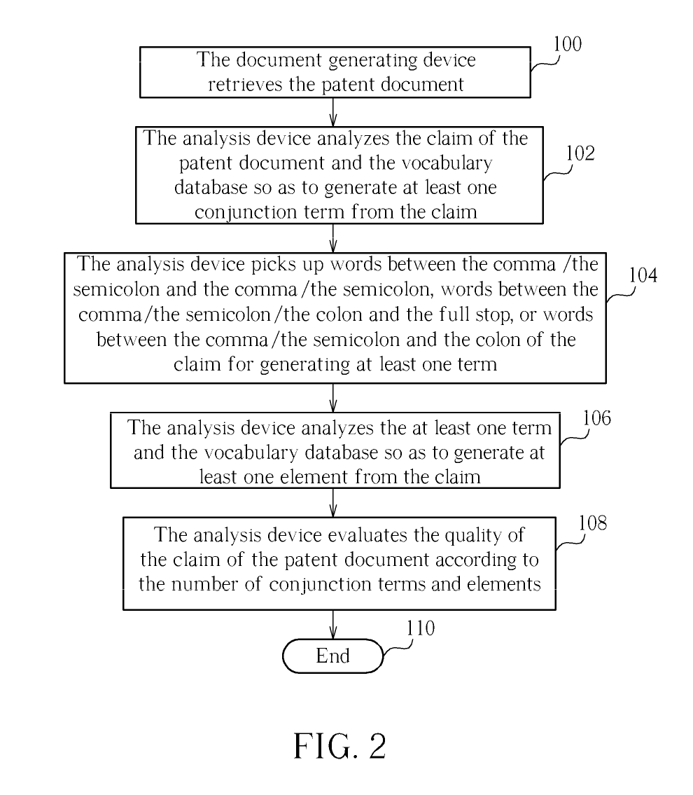

Please refer to FIG. 2. FIG. 2 is a flow chart of automatically analyzing the claims of the patent document 54 with the patent analysis system 50 according to the preferred embodiment of the present invention. The method includes:

Step 100: The document generating device 52 retrieves the patent document 54.

Step 102: The analysis device 60 analyzes the claim of the patent document 54 and the vocabulary database 58 so as to generate at least one conjunction term from the claim.

Step 104: The analysis device 60 picks up words between a comma/a semicolon and the comma/the semicolon, words between the comma/the semicolon/a colon and a full stop, or words between the comma/the semicolon and the colon of the claim for generating at least one term.

Step 106: The analysis device 60 analyzes the at least one term and the vocabulary database 58 so as to generate at least one element from the claim.

Step 108: The analysis device 60 evaluates the quality of the claim of the patent document according to the number of conjunction terms and elements,

Step 110: End.

Detailed description of the above-mentioned method is introduced as follows. In step 100, the document generating device 52 can retrieve the patent document 54. For example, the document generating device 52 can receive information of the patent document 54, such as the application number, the publication number, the patent number, the name of the inventor, and so on, and can retrieve the corresponding patent document 54 from the patent database 53 according to the information of the patent document 54. On the other hand, the analysis device 60 also can retrieve the corresponding patent number 54 from the patent document database 57 directly. The patent document 54 includes at least one claim, and a user can enter a serial number of the analyzing claim of the patent document 54 for executing analysis process. After that, in step 102, the analysis device 60 analyzes the claim of the patent document 54 and the vocabulary database 58, so as to generate at least one conjunction term in the claim. The conjunction term defines relation between the elements, which can be considered as a limitation of the claim. For example, if the claim recites “a bar pivoted to a base”, “pivot” represents the relation between “the bar” and “the base”, so that the conjunction term of “pivot” can be generated by analyzing the claim and the vocabulary database 58. In addition, if the claim recites “disposing an electrode layer on a substrate”, because “disposing” represents the relation between “the substrate” and “the electrode layer”, so that the conjunction term of “disposing” can be generated by analyzing the claim and the vocabulary database 58. The analysis device 60 can further calculate the number of the conjunction terms of the claim, so as to evaluate the quality of the claim. Besides, the analysis device 60 can further analyze the terms adjacent the conjunction term so as to identify a valid number of the conjunction terms for preventing the conjunction terms having the same meaning from being analyzed repeatedly. The term can be a structural element, a step, or a chemical element. For example, the analysis device 60 can identify two conjunction terms having equivalent substantial limitation as a single conjunction term when analyzing the terms adjacent to the two conjunction terms are identical. For example, if the claims simultaneously recite “an end of the bar fixed on a base” and “a base disposed on an end of a bar”, the two conjunction terms “fix” and “dispose” are connected between the same terms “bar” and “base” and the two conjunction terms have equivalent limitations so that the analysis device 60 identifies the valid number of the conjunction terms accurately.

In step 104, the analysis device 60 analyzes the elements in the claim. Basically, the claim includes the elements and the conjunction terms connected between the elements, so that the elements can be picked up from the claim with the analysis device 60. For example, the analysis device 60 picks up the words between the comma and the comma, the words between the comma and the semicolon, the words between the semicolon and the comma, the words between the semicolon and the semicolon, the words between the comma and the full stop, the words between the semicolon and the full stop, the words between the colon and the full stop, the words between the comma and the colon, or the words between the semicolon and the colon of the claim, so as to generate at least one term. The at least one term may be the element. In step 106, the analysis device 60 analyzes the at least one term and the vocabulary database 58, so as to generate at least one element of the claim. That is to say, the element having accurate limitation can be derived by analyzing the above generated term. For example, when the analysis device 60 analyzes the at least one term and the vocabulary database 58 to generate the necessary term, the necessary term is irrelevant to the quality of the claim and is not considered as the element. When the analysis device 60 analyzes the at least one term and the vocabulary database 58 to generate the term logically paired with other term, the pair of terms can be considered as the elements appearing in the claim in pair consequentially so that the pair of terms is considered as the single element. When the analysis device 60 analyzes the at least one term and the vocabulary database 58 to generate the term correlated with other terms, the correlated terms are the elements having the same meaning in the claim so that the plurality of correlated terms can be considered as the single element. The above-mentioned terms, such as the conjunction term, the necessary term, the term logically paired with other term, the term correlated with other terms, and so on, can be set according to the different specific technology domains or according to the different patent forms. Furthermore, the elements in the claim are not limited to the above-mentioned terms, and can be selected from a group consisting of the conjunction term, the necessary term, the term logically paired with other term, the term correlated with other terms, the other additional terms, and a combination thereof. Besides, sequence of step 102, step 104, and step 106 can be exchangeable, which means the analysis device 60 can analyze the element after analyzing the conjunction term, or can analyze the conjunction term after analyzing the element.

Finally, in step 108, the analysis device 60 can evaluate the quality of the claim according to the number of conjunction terms and elements. The number of conjunction terms and the elements is calculated with the analysis device 60. The number of conjunction terms and elements calculated by the analysis device 60 is inversely proportional to the quality of the claim. This is means that the more elements and conjunction terms in the claim, and the low quality of patent document is, and the analysis device 60 identifies the narrower claim accordingly. On the other hand, less conjunction terms and elements in the claim represent less limitation of the claim, and the analysis device 60 identifies the wider claim accordingly. In addition, evaluation of the quality of the claim can be adjusted according to actual demand. For example, weighting ratios of the conjunction term and the element can be set respectively, or different weighting ratios of an independent claim and a dependent claim can be set respectively, so as to evaluate quality of the claims. Besides, the analysis device 60 can calculate the rating of the patent document 54 according to the valid number of the conjunction term of the at least one claim, and can output the rating of the patent document 54 via the output interface 62. Further, the analysis device 60 can identify the grade of the patent document 54 according to the rating of the patent document 54, such as identifying different grades for the patent document 54 according to its rating, like an offense grade, a defense grade, a useless grade, and so on. Then, the analysis device 60 outputs the grade of the patent document 54 via the output interface 62, so that the user can manage the patent documents according to the quality of the claim, the rating, and the grade of the patent document 54. For example, the analysis device 60 can analyze the patent documents according to the quality of the claim, so as to respectively classify the patent documents as the offense grade, the defense grade, or the useless grade. Therefore, the patent document 54 can be analyzed through objective indexes in place of personal identification. The patent analysis system 50 can analyze the quality of the patent document automatically, so as to economize analyzing hours and to pick out the useful patent document rapidly.

Comparing to the prior art, the present invention provides the method of automatically evaluating quality of the patent document by analyzing the number of conjunction terms and the elements in the claims and the related patent analysis system. That is to say, the present invention not only analyzes the element of the claim for evaluating the importance of the patent document, but also analyzes the conjunction term connected between the elements so as to preferably evaluate the quality of the patent document for providing an objective estimation of the patent document.

Those skilled in the art will readily observe that numerous modifications and alterations of the device and method may be made while retaining the teachings of the invention.

What is claimed is:

1. A method of analyzing claims of a patent document comprising:
retrieving a patent document having at least one claim;
analyzing the claim and a vocabulary database so as to generate at least one conjunction term of the claim with an analysis device; and
evaluating quality of the claim according to the at least one conjunction term with the analysis device.

2. The method of claim 1, wherein evaluating the quality of the claim according to the at least one conjunction term with the analysis device comprises calculating the number of the at least one conjunction term so as to evaluate the quality of the claim with the analysis device.

3. The method of claim 2, wherein the number of the at least one conjunction term calculated by the analysis device is inversely proportional to the quality of the claim.

4. The method of claim 1 further comprising:
analyzing a term adjacent the at least one conjunction term so as to identify a valid number of the at least one conjunction term with the analysis device.

5. The method of claim 4, wherein analyzing the term adjacent the at least one conjunction term so as to identify the valid number of the at least one conjunction term with the analysis device comprises identifying two conjunction terms having equivalent substantial limitation as a single conjunction term when the terms adjacent to the two conjunction terms are identical.

6. The method of claim 4 further comprising:
generating a rating of the patent document and outputting the rating of the patent document according to the valid number of the conjunction term of the at least one claim with the analysis device.

7. The method of claim 6 further comprising:
identifying a grade of the patent document and outputting the grade of the patent document according to the rating of the patent document with the analysis device.

8. The method of claim 1 further comprising:
picking words between a comma/a semicolon and the comma/the semicolon, words between the comma/the semicolon/a colon and a full stop, or words between the comma/the semicolon and the colon of the claim for generating at least one term with the analysis device;
analyzing the at least one term and the vocabulary database so as to generate at least one element of the claim with the analysis device; and
evaluating the quality of the claim according to the at least one element with the analysis device.

9. The method of claim 8, wherein analyzing the at least one term and the vocabulary database so as to generate the at least one element of the claim with the analysis device comprises obviating a necessary term from the element in a technology domain corresponding to the claim as the necessary term is generated by analyzing the at least one term and the vocabulary database.

10. The method of claim 8, wherein analyzing the at least one term and the vocabulary database so as to generate the at least one element of the claim with the analysis device comprises considering a term logically paired with other term as the element when the pair of terms is generated by analyzing the at least one term and the vocabulary database.

11. The method of claim 8, wherein analyzing the at least one term and the vocabulary database so as to generate the at least one element of the claim with the analysis device comprises considering a term correlated with other terms as the element when a plurality of correlated terms is generated by analyzing the at least one term and the vocabulary database.

12. The method of claim 8, wherein the number of the at least one element calculated with the analysis device is inversely proportional to the quality of the claim.

13. The method of claim 1, wherein retrieving the patent document comprises retrieving the patent document in a patent database according to information of the patent document with a document generating device.

14. A patent analysis system comprising:
a storage module for storing a patent document and a vocabulary database, the patent document comprising at least one claim; and
an analysis device for analyzing the claim and the vocabulary database so as to generate at least one conjunction term of the claim and to evaluate quality of the claim according to the at least one conjunction term.

15. The patent analysis system of claim 14, wherein the analysis device is further for calculating the number of the at least one conjunction term to evaluate the quality of the claim.

16. The patent analysis system of claim 15, wherein the number of the at least one conjunction term calculated with the analysis device is inversely proportional to the quality of the claim.

17. The patent analysis system of claim 14, wherein the analysis device is further for analyzing a term adjacent the at least one conjunction term to identify a valid number of the at least one conjunction term.

18. The patent analysis system of claim 17, wherein the analysis device is further for identifying two conjunction terms having equivalent substantial limitation as a single conjunction term when the terms adjacent to the two conjunction terms are identical.

19. The patent analysis system of claim 17, wherein the analysis device is further for generating a rating of the patent document according to the valid number of the conjunction term of the at least one claim, and the patent analysis system further comprises an output interface for outputting the rating of the patent document generated by the analysis device.

20. The patent analysis system of claim 19, wherein the analysis device is further for identifying a grade of the patent document according to the rating of the patent document, and the output interface is further for outputting the grade of the patent document generated by the analysis device.

21. The patent analysis system of claim 14, wherein the analysis device is further for picking up words between a comma/a semicolon and the comma/the semicolon, words between the comma/the semicolon/a colon and a full stop, or words between the comma/the semicolon and the colon of the claim so as to generate at least one term, and further for analyzing the at least one term and the vocabulary database so as to generate at least one element of the claim and to evaluate the quality of the claim according to the at least one element.

22. The patent analysis system of claim 21, wherein the analysis device is further for obviating a necessary term from the element in a technology domain according to the claim as the analysis device generates the necessary term by analyzing the at least one term and the vocabulary database.

23. The patent analysis system of claim 21, wherein the analysis device is further for considering a term logically paired with other term as the element when the analysis device generates the pair of terms by analyzing the at least one term and the vocabulary database.

24. The patent analysis system of claim 21, wherein the analysis device is further for considering a term correlated with other terms as the element when the analysis device generates a plurality of correlated terms by analyzing the at least one term and the vocabulary database.

25. The patent analysis system of claim 21, wherein the number of the at least one element calculated with the analysis device is inversely proportional to the quality of the claim.

26. The patent analysis system of claim 14 further comprising:
a document generating device for retrieving the patent document in a patent database according to information of the patent document.
